(19) United States
(12) Patent Application Publication
(10) Pub. No.: US 2024/0405296 A1
(43) Pub. Date: Dec. 5, 2024

(54) Thermally Stable Hybrid Separator for a Lithium Battery or Sodium Battery and Manufacturing Method

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/327,533

(22) Filed: Jun. 1, 2023

(51) Int. Cl. H01M 10/42; H01M 10/0525; H01M 10/054; H01M 10/0562; H01M 50/383; H01M 50/403; H01M 50/42; H01M 50/423; H01M 50/491

(52) U.S. Cl. CPC H01M 10/4235; H01M 10/0525; H01M 10/054; H01M 10/0562; H01M 50/383; H01M 50/403; H01M 50/42; H01M 50/423; H01M 50/491; H01M 2300/0068; H01M 2300/0071

(57) ABSTRACT

Provided is a polymer hybrid separator for use in a battery, the separator comprising multiple fibers of a first thermally stable polymer (first fibers) and multiple fibers of a second thermally stable polymer (second fibers), which are different in chemical composition or diameter than the first fibers, wherein the first fibers intersect with the second fibers and are bonded by the second fibers at the points of intersection. The thermally stable polymer fibers preferably have a melting point or thermal decomposition temperature higher than 250° C. (preferably >300° C., further preferably >400° C., still further preferably >500° C., and most preferably >600° C.). Also provided are a process for producing such a separator and a lithium or sodium secondary battery comprising a cathode, an anode, such a separator disposed between the cathode and the anode, and an electrolyte.

### FIELD

The present invention relates to the field of rechargeable lithium battery or sodium battery, including the lithium-ion battery, lithium metal battery, sodium-ion battery, and sodium metal battery and, in particular, to a separator or anode protection layer for a secondary battery.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li_{4.4}Si) as an anode active material. Hence, in general, rechargeable Li metal batteries have a significantly higher energy density than lithium-ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990's giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery.” U.S. Pat. No. 5,648,187 (Jul. 15, 1997); U.S. Pat. No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); U.S. Pat. No. 6,797,428 (Sep. 28, 2004); U.S. Pat. No. 6,936,381 (Aug. 30, 2005); and U.S. Pat. No. 7,247,408 (Jul. 24, 2007)] further proposed a multilayer anode structure consisting of a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, consisting of at least 3 or 4 layers, is too complex and too costly to make and use.

Protective coatings for Li anodes, such as glassy surface layers of LiI—Li₃PO₄—P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); U.S. Pat. No. 7,282,296 (Oct. 16, 2007); and U.S. Pat. No. 7,282,302 (Oct. 16, 2007)].

Despite these earlier efforts, no rechargeable Li metal batteries have yet succeeded in the market place. This is likely due to the notion that these prior art approaches still have major deficiencies. For instance, in several cases, the anode or electrolyte structures are too complex. In others, the materials are too costly or the processes for making these materials are too laborious or difficult. Conventional solid electrolytes typically have a low lithium ion conductivity, are difficult to produce and difficult to implement into a battery.

Furthermore, the conventional solid electrolyte, as the sole electrolyte in a cell or as an anode-protecting layer (interposed between the lithium film and another electrolyte) does not have and cannot maintain a good contact with the lithium metal. This reduces the effectiveness of the electrolyte to support dissolution of lithium ions (during battery discharge), transport lithium ions, and allowing the lithium ions to re-deposit back to the lithium anode (during battery recharge). A ceramic separator that is disposed between an anode active material layer (e.g. a graphite-based anode layer or a lithium metal layer) and a cathode active layer suffers from the same problems as well. In addition, a ceramic separator also has a poor contact with the cathode layer if the electrolyte in the cathode layer is a solid electrolyte (e.g., inorganic solid electrolyte).

Another major issue associated with the lithium metal anode is the continuing reactions between liquid electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

As a distinct class of energy storage device, sodium (Na) batteries have been considered an attractive alternative to lithium batteries since sodium is abundant and the production of sodium is significantly more environmentally benign compared to the production of lithium. In addition, the high cost of lithium is a major issue and Na batteries potentially can be of significantly lower cost.

There are at least two types of batteries that operate on bouncing sodium ions (Na+) back and forth between an anode and a cathode: the sodium metal battery having Na metal or alloy as the anode active material and the sodium-ion battery having a Na intercalation compound as the anode active material. Sodium ion batteries using a hard carbon-based anode active material (a Na intercalation compound) and a sodium transition metal phosphate as a cathode have been described by several research groups; e.g., J. Barker, et al. “Sodium Ion Batteries,” U.S. Pat. No. 7,759,008 (Jul. 20, 2010).

Sodium-ion cells and sodium metal cells suffer from similar problems as lithium-ion cells and lithium metal cells.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Hence, an object of the present disclosure was to provide an effective way to overcome the lithium metal dendrite and reaction problems in all types of Li metal batteries having a lithium metal anode. A specific object of the present disclosure was to provide a lithium cell (either lithium-ion cell or lithium metal cell) that exhibits a high specific capacity, high specific energy, high degree of safety, and a long and stable cycle life.

### SUMMARY

The present disclosure provides a polymer hybrid separator for use in a battery, the polymer hybrid separator comprising multiple fibers of a first thermally stable polymer (herein referred to as first fibers) and multiple fibers of a second thermally stable polymer (herein referred to as second fibers), which are different in chemical composition or diameter than the first fibers, wherein the first fibers intersect with the second fibers and are bonded by the second fibers and wherein the first thermally stable polymer, the second thermally stable polymer, or both the first and the second thermally stable polymer are selected from the group consisting of polyimide, poly(amic acid), poly(amide imide), poly(ether imide), aromatic polyamide, polysulfone, polyether sulfone, poly(phenylene sulfide), poly(phenylene sulfide sulfone), phenolic resin, polyacrylonitrile, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly(p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzo-phenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof and wherein the hybrid separator has a thickness from 50 nm to 300 μm (preferably <100 μm, more preferably <50 μm, and further preferably <20 μm).

In the polymer hybrid separator, the multiple fibers may be in a form of a mat, nonwoven fabric, woven fabric, braded structure, or knitted structure. In certain preferred embodiments, the multiple fibers intersect one another at multiple intersection points and the multiple fibers are bonded together by the fibers of the second thermally stable polymer at these intersections.

There are no limitations on what type of thermally stable polymer fibers that can be used to practice the present invention. The diameters of the fibers are preferably less than 30 μm, more preferably less than 20 μm, further preferably less than 10 μm, still further preferably less than 1 μm, and most preferably from 2 nm to 1 μm. Some nano-fibers can have a diameter from 2 nm to 100 nm (inclusive). Sub-micron fibers have a diameter from 100 nm to 1 μm.

For instance, the polymer fibers may be chosen to be poly(amide imide) nano-fibers prepared by electro-spinning and these poly(amide imide) nano-fibers are bonded by fibers a polyimide (PI). As another example, one may first produce PI nano-fibers, which are bonded by a different or the same type of polyimide (but having a different diameter) at the intersection points of PI nano-fibers. This bonding polyimide may be initially in a polyamic acid form (a reactive precursor), which is applied to the PI nano-fibers and then cured to become polyimide fibers.

The polymer hybrid separator may further comprise from 0.1% to 50% (preferably from 1% to 30%) by weight of a lithium salt dispersed in the thermally stable polymer fibers.

The lithium salt in the polymer composite separator may be selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In certain embodiments, the hybrid separator further comprises an inorganic material selected from (a) particles or fibers of a transition metal oxide, aluminum oxide, silicon dioxide, transition metal sulfide, transition metal selenide, alkylated ceramic particles, metal phosphate, metal carbonate, or a combination thereof or (b) particles or fibers of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

The polymer composite separator preferably has a porosity level from 5% to 95% by volume, preferably from 30% to 80%.

In some embodiments, the polymer hybrid separator further comprise pores and an ion-conducting polymer residing in the pores, wherein the ion-conducting polymer is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof and wherein the lithium ion-conducting polymer is not in a fibrous form.

The polymer hybrid separator may further comprise a flame-retardant additive. The flame-retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

The present disclosure also provides a lithium or sodium secondary battery comprising a cathode, an anode, and a thermally stable polymer hybrid separator (as herein disclosed) disposed between the cathode and the anode, and a working electrolyte.

The electrolyte in the lithium secondary battery may be a liquid electrolyte, polymer gel electrolyte, solid polymer electrolyte, quasi-solid or semi-solid electrolyte, inorganic solid electrolyte, or composite electrolyte, wherein the quasi-solid electrolyte has a lithium salt dissolved in an organic or ionic liquid with a lithium salt concentration higher than 2.0 M. The working electrolyte comprises particles of an inorganic solid electrolyte material selected from an oxide type, sulfide type, hydride type, halide type, borate type, phosphate type, lithium phosphorus oxynitride (LiPON). Garnet-type, lithium superionic conductor (LISICON) type, sodium superionic conductor (NASICON) type, or a combination thereof.

In certain preferred embodiments, in the lithium or sodium secondary battery, the hybrid separator further comprises 30-85% by weight of inorganic material particles selected from a transition metal oxide, aluminum oxide, silicon dioxide, transition metal sulfide, transition metal selenide, alkylated ceramic particles, metal phosphate, metal carbonate, or a combination thereof.

The lithium secondary battery may be a lithium metal battery and the anode has an anode current collector but initially the anode has no lithium or lithium alloy as an anode active material supported by said anode current collector when the battery is made and prior to a charge or discharge operation of the battery. Alternatively, the lithium secondary battery is a lithium metal battery and the anode has an anode current collector and an amount of lithium or lithium alloy as an anode active material supported by said anode current collector.

In certain embodiments, the battery is a lithium-ion battery and the anode has an anode current collector and a layer of an anode active material supported by the anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

There is no theoretical limitation on the cathode active materials in the disclosed battery. The cathode active material may be selected from an inorganic material, an organic material, a polymeric material, or a combination thereof. The inorganic material may be selected from a metal oxide, metal phosphate, metal silicide, metal selenide (e.g., lithium polyselides for use in a Li—Se cell or sodium polyselides in a Na—Se cell), metal sulfide (e.g., lithium or sodium polysulfide for use in a Li-Sor Na—S cell), sulfur, selenium, or a combination thereof. Preferably, these cathode active materials contain lithium in their structures; otherwise, the cathode should contain a lithium source.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, which is selected from a carbon material, graphene, electronically conductive polymer, conductive metal oxide, or conductive metal coating.

The disclosure also provides a process for manufacturing a thermally stable polymer hybrid separator, the process comprising (A) mixing multiple fibers of the first thermally stable polymer with multiple fibers of a chemically active precursor to the second thermally stable polymers to form a fiber mixture layer, wherein fibers of the first thermally stable polymer intersect (physically contact with) the precursor fibers; and (B) chemically converting the precursor fibers to the second thermally stable polymer fibers which bond the fibers of the first thermally stable polymer to form said polymer hybrid separator comprising a cross-linked network of two types of fibers. In some embodiments, the multiple fibers of the second thermally stable polymer also bond to one another.

Step (A) may comprise (i) electrostatically co-spinning fibers of the first thermally stable polymer and precursor fibers of the second thermally stable polymer together to form a membrane layer, or (ii) preparing a porous structure comprising multiple fibers of the first thermally stable polymer and electro-spinning precursor fibers of the second thermally stable polymer to intersect the first fibers. Step (B) may comprise chemically converting said precursor fibers under heat, ultraviolet light, high energy radiation, electron beam, or a combination thereof and optionally under a compression stress.

The process may further comprise a step of combining an anode, said polymer hybrid separator, an electrolyte, and a cathode electrode to form a battery.

The disclosure also provides a process for manufacturing the disclosed polymer hybrid separator, the process comprising (A) mixing multiple fibers of the first thermally stable polymer with multiple fibers of the second thermally stable polymers to form a fiber mixture layer, wherein fibers of the first thermally stable polymer intersect (physically contact with) the fibers of the second thermally stable polymer; and (B) heating and partially melting or using a solvent to partially dissolve fibers of the second thermally stable polymer fibers, followed by solidifying the partially melted or dissolved fibers that bond the fibers of the first thermally stable polymer, optionally under a compression stress, to form the polymer hybrid separator comprising a cross-linked network of two types of fibers. Solidification may be simply conducted by cooling the partially melted (surface melted) second type fibers or removing the liquid solvent from the partially dissolved (surface dissolved) second type fibers.

The process may further comprise a step of combining an anode, said polymer hybrid separator, an electrolyte, and a cathode electrode to form a battery.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently invented lithium metal battery cell (upper diagram) containing an anode current collector (e.g., Cu foil) but no anode active material (when the cell is manufactured or in a fully discharged state), a polymer composite separator, and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the composite separator layer when the battery is in a charged state.

FIG. 3 Schematic of a polymer hybrid separator layer wherein multiple fibers are inter-bonded together to form a highly porous mat according to some embodiments of the present disclosure.

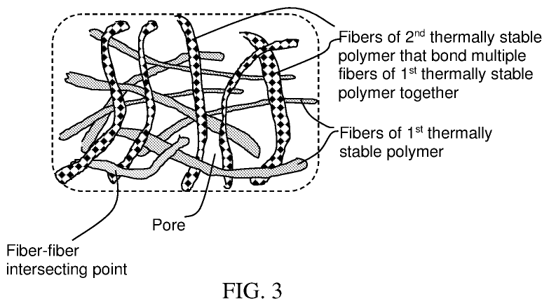

FIG. 4 Schematic of a process of producing the disclosed polymer hybrid membrane (separator) according to certain embodiments of the present disclosure.

### DETAILED DESCRIPTION

This disclosure is related to a lithium secondary battery or sodium secondary battery, which is preferably based on a working electrolyte selected from an organic electrolyte, a polymer gel electrolyte, a solid polymer electrolyte, an ionic liquid electrolyte, a quasi-solid electrolyte, or an inorganic solid-state electrolyte in the anode and/or the cathode. The anode and the cathode are separated by a solid-state polymer hybrid separator. The shape of a lithium or sodium secondary battery can be cylindrical, square, prismatic, pouch, button-like, etc. The present invention is not limited to any battery shape or configuration or any type of electrolyte.

The present disclosure provides a lithium or sodium secondary battery comprising a cathode, an anode, a thermally stable polymer hybrid separator disposed between the cathode and the anode, and a working electrolyte. This separator layer can also serve as an anode protection layer in a lithium metal cell or sodium metal cell.

The present disclosure provides a polymer hybrid separator for use in a battery, the polymer hybrid separator comprising multiple fibers of a first thermally stable polymer (herein referred to as first fibers) and multiple fibers of a second thermally stable polymer (herein referred to as second fibers), which are different in chemical composition or diameter than the first fibers, wherein the first fibers intersect with the second fibers and are bonded by the second fibers and wherein the first thermally stable polymer, the second thermally stable polymer, or both the first and the second thermally stable polymer are selected from the group consisting of polyimide, poly(amic acid), poly(amide imide), poly(ether imide), aromatic polyamide, polysulfone, polyether sulfone, poly(phenylene sulfide), poly(phenylene sulfide sulfone), phenolic resin, polyacrylonitrile, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly(p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzo-phenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof and wherein the hybrid separator has a thickness from 50 nm to 300 μm (preferably <100 μm, more preferably <50 μm, and further preferably <20 μm).

In general, the first thermally stable polymer and the second thermally stable polymer are different in chemical composition and/or in fiber diameter. The two types of polymers can be from the same generic group of polymers (e.g., both belonging to the polyether imide group), but their chemical compositions can be different (e.g., from different monomers; or one being a thermoset polymer and the other a thermoplastic polymer). Even if their chemical compositions are identical, they can be made into fibers of vast different diameters (e.g., one in the range of 50-100 nm and the other of 200-1000 nm); the sizes can be adjusted to impart better packing of the resulting membrane having better pore size control.

The fibers of a thermally stable polymer can be made into a porous fibrous structure (porous preform), such as a mat, nonwoven, woven fabric, etc. Nonwoven separators, which provide high porosity can be made by using a paper making method, solution extrusion method, melt blowing method, and electrospinning method.

These thermally stable polymers have a high thermo-oxidative degradation temperature, typically having a degradation temperature higher than 300° C., more typically higher than 350° C., further typically higher than 400° C., some even higher than 500° C., or higher than 650° C. However, these polymers of high thermal stability are not known to have a high lithium-ion conductivity and, hence, not believed to be useful as a separator material in a lithium battery. The incorporation of from 0.1% to 50% by weight of a lithium salt in the hybrid separator (e.g., dispersed in thermally stable polymer fibers) can significantly increase the lithium-ion conductivity of the separator.

The lithium salt in the polymer composite separator may be selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

The use of particles of an inorganic solid electrolyte material, residing in pores or interstices between fibers, can also significantly increase the ion conductivity. In certain embodiments, the inorganic material comprises particles of an inorganic solid electrolyte material selected from an oxide type, sulfide type, hydride type, halide type, borate type, phosphate type, lithium phosphorus oxynitride (LiPON). Garnet-type, lithium superionic conductor (LISICON) type, sodium superionic conductor (NASICON) type, or a combination thereof. Alternatively or additionally, the inorganic material particles may comprise a material selected from a transition metal oxide, aluminum oxide, silicon dioxide, transition metal sulfide, transition metal selenide, alkylated ceramic particles, metal phosphate, metal carbonate, or a combination thereof.

The polymer composite separator preferably has a porosity level from 5% to 95% by volume, preferably from 30% to 80%. In some embodiments, the polymer hybrid separator further comprise pores and an ion-conducting polymer residing in the pores, wherein the lithium ion-conducting polymer is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof and wherein the lithium ion-conducting polymer is not in a fibrous form.

Several examples of thermally stable polymers that can be made into fibers will be briefly discussed in what follows: Polyimide (PI) is a polymer of imide monomers belonging to the class of thermally stable polymers. A classic polyimide is Kapton, which is produced by condensation of pyromellitic dianhydride and 4,4′-oxydianiline. Polyimides exist in two formats: thermosetting and thermoplastic. Depending upon the constitution of their main chain, polyimide can be classified as aliphatic, aromatics, semi-aromatics. Aromatic polyimides are derived from an aromatic dianhydride and diamine.

Semi-aromatic PIs contain any one of the monomer aromatics: i.e., either the dianhydride or diamine is aromatic, and the other part is aliphatic. Aliphatic polyimides consist of the polymers formed as a result of the combination of aliphatic dianhydride and diamine. Some examples of PI structures are given below:

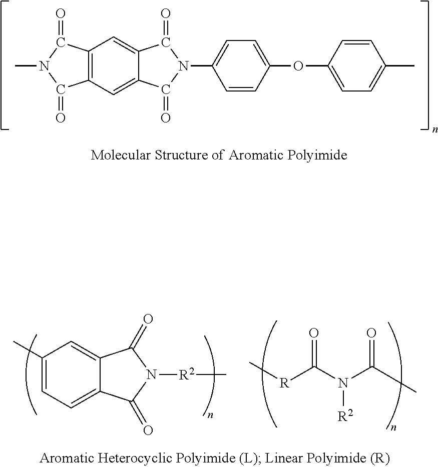

Several methods can be used to prepare polyimides; e.g., (i) the reaction between a dianhydride and a diamine (the most used method) and (ii) the reaction between a dianhydride and a diisocyanate. The desired lithium salt may be added into either or both the reactants, or the resultant oligomers. One may also add the lithium salt into the intermediate poly(amid acid).

The polymerization of a diamine and a dianhydride can be conducted by a two-step method in which a poly(amid acid) is prepared first or directly by a one-step method. The two-step method is the most widely used procedure for polyimide synthesis. At first a soluble poly(amic acid) is prepared which is cyclized after further processing in a second step to the polyimide. A two-step process is necessary because the final polyimides are in most cases infusible and insoluble due to their aromatic structure.

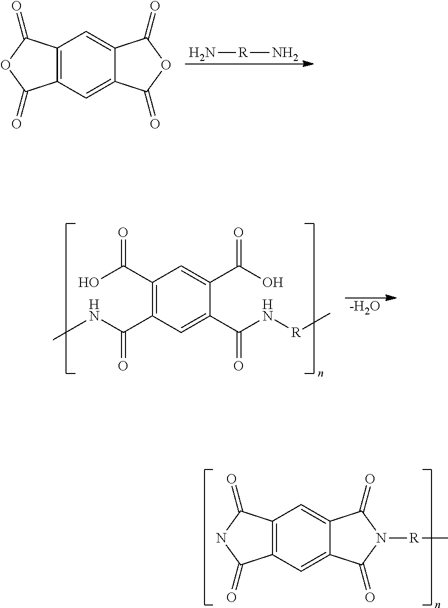

Dianhydrides used as precursors to these materials include pyromellitic dianhydride, benzoquinonetetracarboxylic dianhydride and naphthalene tetracarboxylic dianhydride. Common diamine building blocks include 4,4′-diaminodiphenyl ether (“DAPE”), meta-phenylene diamine (“MDA”), and 3,3-diaminodiphenylmethane. Hundreds of diamines and dianhydrides have been examined to tune the physical and especially the processing properties of PIs. These materials tend to be insoluble and have high softening temperatures, arising from charge-transfer interactions between the planar subunits.

Highly soluble phenylethynyl-endcapped isoimide oligomers can be synthesized using 2,3,3′,4′-biphenyltetracarboxylic dianhydride (3,4′-BPDA) and aromatic diamines as the monomers, 4-phenylethynyl phthalic anhydride (4-PEPA) as the end-capping reagent, and trifluoroacetic anhydride as the dehydrating agent. Subsequently, thermosetting polyimides and PI composites can be produced from these oligomers via the thermal crosslinking reaction of the phenylethylnyl group. The composite separator layers may be produced by adding a desired amount of fibers (polymer fibers, glass fibers, or ceramic fibers) and, optionally, inorganic filler (e.g., SiO₂ nano particles or particles of a solid inorganic electrolyte) in the oligomer.

For instance, a series of isoimide oligomers with different molecular weights and a variety of chemical architectures can be prepared by polycondensation of 3,4′-BPDA, 4-PEPA, and aromatic diamines including m-phenylenediamine (m-PDA), 2,2′-bis(trifluoromethyl) benzidine (TFMB), and 3,4′-oxydianiline (3,4′-ODA), followed by cyclization with trifluoroacetic anhydride. Compared to their imide analogues, isoimide oligomers can exhibit much higher solubility in low boiling point solvents, and slightly lower melt viscosity. These resins can be formulated into thermosetting polyimides and composites by thermal crosslinking of the phenylethynyl group and conversion from isoimide to imide at elevated temperatures. The cured polyimides can exhibit extremely high glass transition temperatures (T_{g}) up to 467° C., and 5% weight loss temperatures (T_{5%}) up to 584° C. in a nitrogen atmosphere. The polyimide-inorganic filler composites can possess high glass transition temperatures and thermal stability.

Poly [2,2′-(m-phenylene)-5,5′-bibenzimidazole] (PBI) is a thermally stable polymer synthesized from tetra-aminobiphenyl-(3,3′-diaminobenzidine) and diphenyl isophthalate. It is used in different forms, such as fibers, composites, and neat resin, primarily for high-temperature applications. PBI has excellent dimensional stability at high temperatures, and it emits very little smoke when it is exposed to extremely high temperatures. This feature is particularly helpful for lithium battery applications. It is resistant to chemicals, and it retains its integrity even when charred.

Polyquinolines are versatile, thermally stable polymers and are characterized by repeating quinoline units, which display a catenation pattern of 2,6, 2,4, or 3,6 units. Polyquinolines are formed by the step-growth polymerization of o-aminophenyl ketone monomers and ketone monomers containing a hydrogens (mostly acetophenone derivatives):

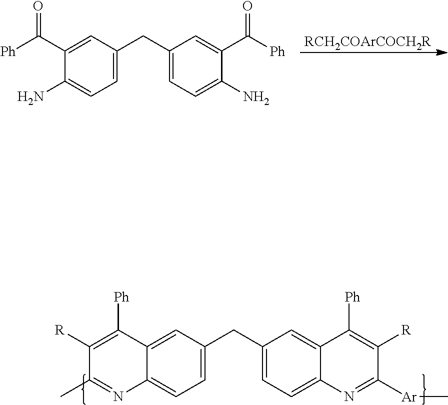

Alternatively, they may be prepared by the Friedländer reaction, which involves either an acid- or a base-catalyzed condensation of an o-aminoaromatic aldehyde or ketone with a ketomethylene compound. Polyquinolines have also been obtained by a postpolymerization thermal treatment of poly(enaminonitriles). The resulting polymers show excellent thermal stability, with initial weight losses occurring between 500° C. and 600° C. in air.

Polyimide is an important thermally stable polymer. Wide variations of the monomers and the precursors make polyimide a suitable candidate to be used as one component of a polymer alloy (mixture, co-polymer, semi-interpenetrating network, etc.). For instance, polymer alloys of a polybenzoxazine and a polyimide was prepared by blending B-a (see the figure below) as a benzoxazine with a poly(amide acid), PAA, as a precursor of polyimide, followed by film casting (e.g., along with multiple fibers) and thermal treatment for the ring-opening polymerization of the benzoxazine and imidization.

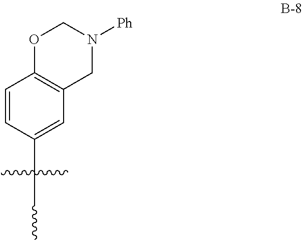

Various types of PAA were prepared as shown in the below figure:

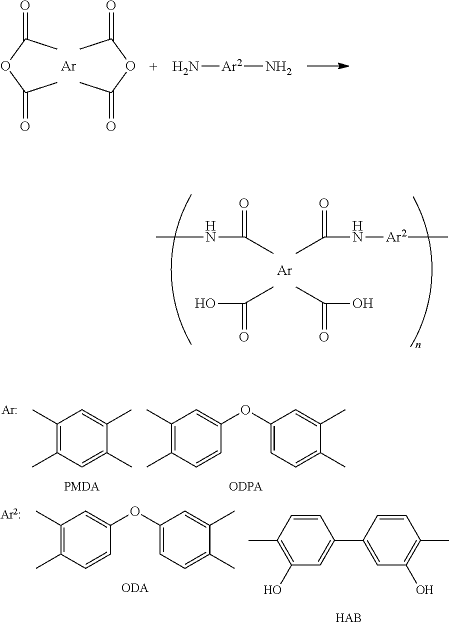

The onset temperature of the exotherm due to the ring-opening polymerization can decrease by as much as ˜80° C. by blending B-a with a PAA because of the catalytic effect of the carboxylic group in the PAA. The resulting alloy films are considered to form a semi-interpenetrating polymer network (semi-IPN) consisting of a linear polyimide and a crosslinked polybenzoxazine or to form an AB-co-crosslinked polymer network by the copolymerization of benzoxazine with polyimide containing a pendent phenolic hydroxyl:

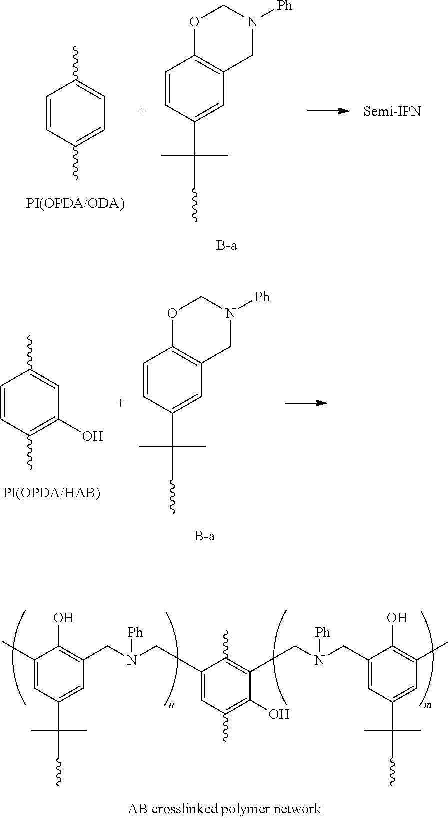

The semi-IPN polymers gave two T_{g}s, while the AB-co-crosslinked polymers gave only one T_{g}. Both types of polymer alloys were effective to improve the brittleness, the T_{g} and the thermal degradation temperature of polybenzoxazine. The semi-IPN formation was especially effective for toughening the polybenzoxazine, while the AB-co-crosslinked polymer network was effective for increasing T_{g}.

Another type of thermally stable polymers is polyphthalonitrile resins. Intensive investigations on high-temperature polymers have led to the development of a broad array of thermos-oxidatively stable materials. Phthalonitrile resins are an addition to this unique class of addition-curable, high-temperature polymeric material. Structural modifications through the incorporation of thermally stable groups such as fluorine, imide, and benzoxazine enable the development of resin systems with tunable properties. The structure-property relationship in these polymers, the role of different curatives, the processability, and the corresponding crosslinking mechanisms have been studied. The scenario of self-cure-promoting phthalonitriles has been proposed that would accelerate the cure schedule required to attain the complete nitrile curing.

Polycondensations of 1,4,5,8-naphthalenetetracarboxylic acid (NTCA) with both 3,3′-diaminobenzidine (DAB) and 1,2,4,5-tetraaminobenzene tetrahydrochloride (TAB) in polyphosphoric acid (PPA) were found to produce soluble polymers which exhibit excellent thermal stabilities. The solubility in certain solvents is a good feature in the production of polymer composite separator layers. Polymer derived from TAB had a ladder-type structure. Polymers with solution viscosities near 1 or above (determined in H₂SO₄) can be obtained from polymerizations near 200° C., and analysis showed these to possess a very high degree of completely cyclized benzimidazo-benzophenanthroline structure. Less vigorous reaction conditions gave polymers with lower solution viscosities which appeared to be less highly cyclized. Low-viscosity polymer can be prepared from DAB and NTCA by solid-phase polycondensation. Some advancements in the solution viscosities of polymers synthesized from DAB in PPA were caused by second staging in the solid phase.

Another useful class of thermally stable polymers is the ladder polymers. The synthesis of ladder polymers has been performed via Diels-Alder reactions, and based on Tröger's base formation and double aromatic nucleophilic substitution. Many of the synthetic methods result in relatively flexible linkages in polymer backbones except for Tröger's base linkage. Rigid ladder polymers may be synthesized by palladium or nickel-catalyzed annulation (Yan Xia, et al. “Efficient synthesis of rigid ladder polymers,” U.S. Pat. No. 9,708,443, Jul. 18, 2017).

There are a wide variety of rigid-rod and ladder polymers that can be used as a thermally stable polymer in the disclosed polymer composite separators. These thermally stable polymers have a high thermo-oxidative degradation temperature, typically having a degradation temperature higher than 250° C., more typically higher than 300° C., further typically higher than 350° C., some even higher than 400° C., or higher than 450° C.). Several non-limiting examples are given below:

The thermally stable polymers within the contemplation of the present invention include homopolymers having the repeating structural unit:

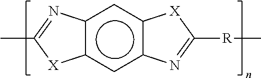

where X is the same or different and is sulfur, oxygen or —NR¹; R is

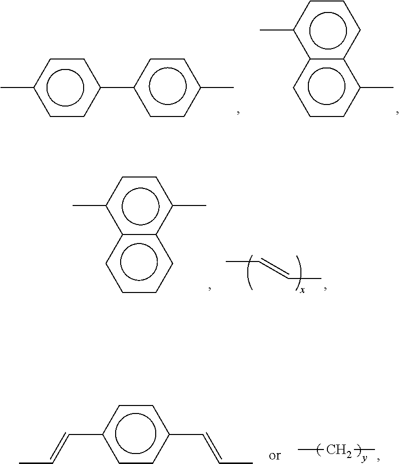

when X is the same or different and is sulfur or oxygen, however, R is nil,

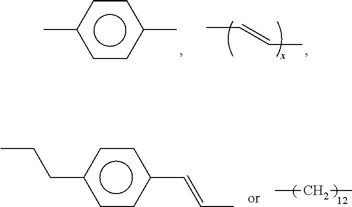

when X is —NR¹; R¹ is hydrogen or hydrocarbyl; x is 1 or 2; y is an integer of 8 to 11; z is 1 or 2; and n is an integer of 2 to 2,000.

Another class of rigid rod and ladder polymers within the contemplation of the present invention is characterized by the repeating structural unit

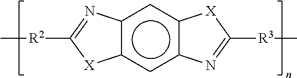

where X, R¹ and n have the meanings given above; R² is

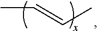

when R³ is

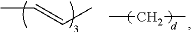

however, R² is

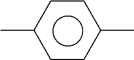

when R³ is

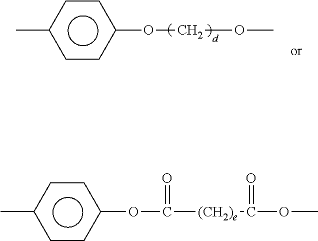

wherein d an integer of 1 to 5; e is an integer of 1 to 18; and f is an integer of 1 to 18.

Yet another class of rigid rod and ladder polymers encompassed by the present invention is a polymer having the repeating structural unit

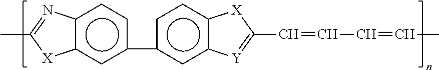

where X and n have the meanings given above.

The present invention is not limited to homopolymers of the repeating structural units recited hereinabove. Copolymers of at least two repeating structural units within the scope of one or more of the above generic repeating structural units are within the contemplation of the present invention.

Production methods for the aforementioned rigid-rod and ladder polymers are well-known in the art. However, it has not been known that these polymers, in combination with multiple fibers, a lithium salt or particles of an inorganic solid electrolyte, can be used as a polymer composite separator that has desired properties such as a high lithium-ion conductivity and the ability to stop the lithium metal dendrite in a lithium metal battery.

In certain embodiments, the anode in the lithium secondary battery has an amount of lithium or lithium alloy as an anode active material supported by an anode current collector. In certain other embodiments, initially the anode has no lithium or lithium alloy as an anode active material supported by an anode current collector when the battery is made and prior to a charge or discharge operation of the battery. This latter configuration is referred to as an anode-less lithium battery. The current collector may be a Cu foil, a layer of Ni foam, a porous layer of nano-filaments, such as graphene sheets, carbon nanofibers, carbon nano-tubes, etc. forming a 3D interconnected network of electron-conducting pathways.

Preferably, this polymer hybrid separator layer is different in composition than the working electrolyte used in the lithium battery and the polymer hybrid layer maintains as a discrete layer (not to be dissolved in the working electrolyte).

We have discovered that this hybrid layer provides several unexpected benefits: (a) the formation and penetration of dendrite can be essentially eliminated when the separator contains particles of an inorganic material; (b) uniform deposition of lithium back to the anode side is readily achieved during battery charging; (c) the layer ensures smooth and uninterrupted transport of lithium ions from/to the anode current collector surface (or the lithium film deposited thereon during the battery operations) and through the interface between the current collector (or the lithium film deposited thereon) and the polymer hybrid separator layer with minimal interfacial resistance; and (d) cycle stability can be significantly improved and cycle life increased. No additional protective layer for the lithium metal anode is required. The separator itself also plays the role as an anode protective layer.

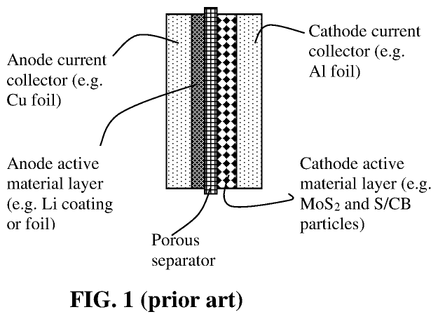

In a conventional lithium metal cell, as illustrated in FIG. 1, the anode active material (lithium) is deposited in a thin film form or a thin foil form directly onto an anode current collector (e.g., a Cu foil) before this anode and a cathode are combined to form a cell. The battery is a lithium metal battery, lithium sulfur battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing a new polymer hybrid separator disposed between the anode (an anode current collector or an anode active material layer) and a cathode active material layer. This polymer hybrid separator layer is permeable to both lithium ions and sodium ions. When containing some lithium salt or sodium salt and/or particles of select inorganic solid electrolyte, the separator layer has a lithium-ion or sodium ion conductivity no less than 10⁻⁸ S/cm at room temperature (preferably and more typically from 1×10⁵ S/cm to 5×10⁻² S/cm).

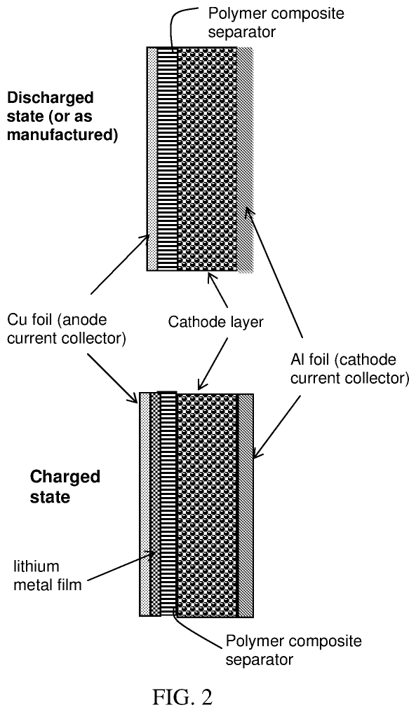

As schematically shown in FIG. 2, one embodiment of the present disclosure is a lithium metal battery cell containing an anode current collector (e.g., Cu foil), an optional anode-protecting layer, a polymer composite-based separator, and a cathode active material layer. The cathode active material layer is composed of particles of a cathode active material, a conductive additive (not shown) and a resin binder (not shown). A cathode current collector (e.g., Al foil) supporting the cathode active layer is also shown in FIG. 2.

It may be noted that FIG. 2 shows a lithium battery that initially does not contain a lithium foil or lithium coating at the anode (only an anode current collector, such as a Cu foil or a graphene/CNT mat) when the battery is made. The needed lithium to be bounced back and forth between the anode and the cathode is initially stored in the cathode active material (e.g., lithium vanadium oxide LiₓV₂O₅, instead of vanadium oxide, V₂O₅; or lithium polysulfide, instead of sulfur). During the first charging procedure of the lithium battery (e.g., as part of the electrochemical formation process), lithium comes out of the cathode active material, passes through the elastic composite separator and deposits on the anode current collector. The presence of the presently invented polymer composite separator (in good contact with the current collector) enables the uniform deposition of lithium ions on the anode current collector surface. Such a battery configuration avoids the need to have a layer of lithium foil or coating being present during battery fabrication. Bare lithium metal is highly sensitive to air moisture and oxygen and, thus, is more challenging to handle in a real battery manufacturing environment. This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically not air-sensitive.

As the charging procedure continues, more lithium ions get to deposit onto the anode current collector, forming a lithium metal film or coating. During the subsequent discharge procedure, this lithium film or coating layer decreases in thickness due to dissolution of lithium into the electrolyte to become lithium ions, creating a gap between the current collector and the protective layer if the separator layer were not elastic. Such a gap would make the re-deposition of lithium ions back to the anode impossible during a subsequent recharge procedure. We have observed that a selected polymer hybrid separator layer, comprising a 3D network of cross-linked or cross-bonded fibers, is capable of expanding or shrinking congruently or conformably with the anode layer. This capability helps to maintain a good contact between the current collector (or the lithium film subsequently or initially deposited on the current collector surface) and the protective layer, enabling the re-deposition of lithium ions without interruption.

Preferably, the inorganic solid electrolyte material is in a fine powder form having a particle size preferably from 10 nm to 30 μm (more preferably from 50 nm to 1 μm). The inorganic solid electrolyte material may be selected from an oxide type (e.g., perovskite-type), sulfide type, hydride type, halide type, borate type, phosphate type, lithium phosphorus oxynitride (LiPON), Garnet-type, lithium superionic conductor (LISICON), sodium superionic conductor (NASICON), or a combination thereof.

The inorganic solid electrolytes that can be incorporated into a thermally stable polymer matrix as an ion-conducting additive to make a separator include, but are not limited to, perovskite-type, NASICON-type, garnet-type and sulfide-type materials. A representative and well-known perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in an elastic polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The highest reported conductivity in this type of material is 6.9×10⁻⁴ S/cm, which was achieved by doping the Li₂S—SiS₂ system with Li₃PO₄. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer.

These solid electrolyte particles dispersed in a thermally stable polymer can help stop the penetration of lithium dendrites (if present) and enhance the lithium-ion conductivity of certain polymers having an intrinsically low ion conductivity.

Preferably, the thermally stable polymer has a lithium-ion conductivity no less than 10⁻⁵ S/cm, more preferably no less than 10⁻⁴ S/cm, further preferably no less than 10⁻³ S/cm, and most preferably no less than 10⁻² S/cm.

Typically, a thermally stable polymer is originally in a monomer or oligomer state that can be polymerized into a linear or branched polymer or cured to form a cross-linked polymer. Prior to curing, these polymers are soluble in an organic solvent to form a reactive polymer solution. This solution may be electro-spun into nano-fibers and two types of polymers can be co-spun into a mat containing intersecting fibers.

The separator can comprise a desired amount of a flame-retardant additive. There is no limitation on the type of flame retardant that can be physically or chemically incorporated into the separator (coated on fiber surfaces, or coated on or dispersed in the thermally stable polymer). The main families of flame retardants are based on compounds containing: Halogens (Bromine and Chlorine), Phosphorus, Nitrogen, Intumescent Systems, Minerals (based on aluminum and magnesium), and others (e.g., Borax, Sb₂O₃, and nanocomposites). Antimony trioxide is a good choice, but other forms of antimony such as the pentoxide and sodium antimonate may also be used.

One may use the reactive types (being chemically bonded to or becoming part of the polymer structure) and additive types (simply dispersed in the polymer matrix). Both reactive and additive types of flame retardants can be further separated into several different classes:
1) Minerals: Examples include aluminum hydroxide (ATH), magnesium hydroxide (MDH), huntite and hydromagnesite, various hydrates, red phosphorus and boron compounds (e.g. borates),
2) Organo-halogen compounds: This class includes organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA), and hexabromocyclododecane (HBCD).
3) Organophosphorus compounds: This class includes organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl) dichloroisopentyldiphosphate (V6).
4) Organic compounds such as carboxylic acid and dicarboxylic acid

The mineral flame retardants mainly act as additive flame retardants and do not become chemically attached to the surrounding system (the polymer). Most of the organohalogen and organophosphate compounds also do not react permanently to attach themselves into the polymer. Certain new non halogenated products, with reactive and non-emissive characteristics have been commercially available as well.

The presently invented lithium secondary batteries can contain a wide variety of cathode active materials. The cathode active material layer may contain a cathode active material selected from an inorganic material, an organic material, a polymeric material, or a combination thereof.

The inorganic cathode active material may be selected from a metal oxide, metal phosphate, metal silicide, metal selenide, transition metal sulfide, sulfur, lithium polysulfide, selenium, lithium selenide, or a combination thereof.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V. Ti, Al, B, Sn, or Bi; and x+y≤1.

Examples of the lithium transition metal oxide- or lithium mixed transition metal oxide-based positive active materials include: Li(M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, where M is a metal, (e.g. Li(Co_{X}Ni_{1-X})O₂ and Li(Co_{X}Fe_{1-X})O₂), Li_{1-W}(Mn_{X}Ni_{X}Co_{Z})O₂, (e.g. Li(Co_{X}Mn_{Y}Ni_{(1-X-Y)}O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂), Li_{1-W}(Mn_{X}Ni_{X}Co₁₋₂ₓ)O₂, Li_{1-W} Mn_{X}Ni_{Y}CoAl_{W})O₂, Li_{1-W}(Ni_{X}Co_{Y}Al_{Z})O₂, where W=0-1, (e.g., Li(Ni_{0.8}Co_{0.15}Al_{0.05})O₂), Li_{1-W}(Ni_{X}Co_{Y}M_{Z})O₂, where M is a metal, Li_{1-W}(Ni_{X}Mn_{Y}M_{Z})O₂, where M is a metal, Li(Ni_{X}Mn_{Y}Cr_{2-X})O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-z}F_{z}, Li₂MnO₃)Li_{X}V_{Y}O_{Z}, e.g. LiV₃O₈, LiV₂O₅, and LiV₆O₁₃. This list includes the well-known lithium nickel cobalt manganese oxides (NCM) and lithium nickel cobalt manganese aluminum oxides (NCM), among others.

The metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%. In some preferred embodiments, prelithiated anode comprises Si that is prelithiated to approximately 60-100% and the cathode comprises a cathode active material that is initially lithium-free.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The working electrolyte used in the lithium battery may be a liquid electrolyte, polymer gel electrolyte, solid-state electrolyte (including solid polymer electrolyte, inorganic electrolyte, and composite electrolyte), quasi-solid electrolyte, ionic liquid electrolyte. The liquid electrolyte or polymer gel electrolyte typically comprises a lithium salt dissolved in an organic solvent or ionic liquid solvent. There is no particular restriction on the types of lithium salt or solvent that can be used in practicing the present inventions. Some particularly useful lithium salts are lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

There is no particular restriction on the selection of anode and cathode materials for a sodium-ion or sodium metal cells. The anode can contain hard carbon, Sn, Sb, Bi, P, etc. as an anode active material.

In certain embodiments, the cathode comprises a cathode active material selected from NaFePO₄, Na₍₁₋ₓ₎ KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ-MnO₂, NaₓK₍₁₋ₓ₎ MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

In certain embodiments, the cathode comprises a cathode active material selected from a Na-based layered oxide, a polyanionic compound, a mixed polyanionic compound, a sulfate, a pyrophosphate, a Prussian Blue analog, or a combination thereof.

In certain embodiments, the cathode comprises a cathode active material selected from Na_{0.7}CoO₂, Na_{0.67}Ni_{0.25}Mg_{0.1}Mn_{0.65}O₂, Na_{0.5} [Ni_{0.23}Fe_{0.13}Mn_{0.63}]O₂, Na_{0.85}Li_{0.17}Ni_{0.21} Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66} Co_{0.5}Mn_{0.5}O₂, Na_{2/3}Li_{1/9} Ni_{5/18}Mn₂₃O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2} Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

There are a wide variety of processes that can be used to produce layers of polymer hybrid separators.

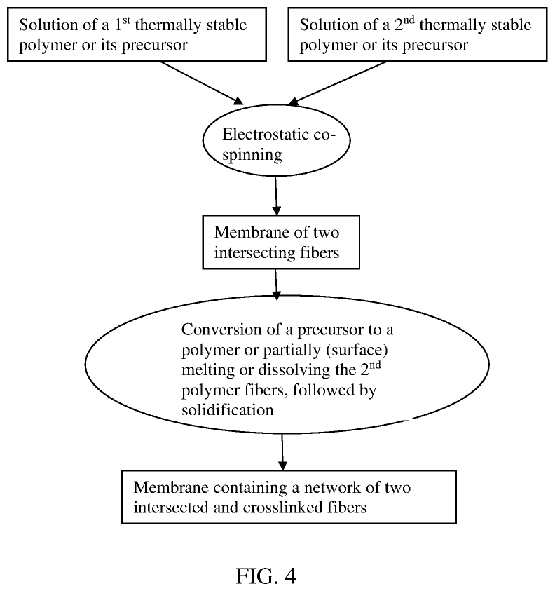

The disclosure also provides a process for manufacturing a thermally stable polymer hybrid separator. As schematically illustrated in FIG. 4, the process comprises: (A) mixing multiple fibers of the first thermally stable polymer with multiple fibers of a chemically active precursor to the second thermally stable polymers to form a fiber mixture layer, wherein fibers of the first thermally stable polymer intersect (physically contact with) the precursor fibers; and (B) chemically converting the precursor fibers to the second thermally stable polymer fibers which bond the fibers of the first thermally stable polymer to form said polymer hybrid separator comprising a cross-linked network of two types of fibers. In some embodiments, the multiple fibers of the second thermally stable polymer also bond to one another.

Step (A) may comprise (i) electrostatically co-spinning fibers of the first thermally stable polymer and precursor fibers of the second thermally stable polymer together to form a membrane layer, or (ii) preparing a porous structure comprising multiple fibers of the first thermally stable polymer and electro-spinning precursor fibers of the second thermally stable polymer to intersect the first fibers. Step (B) may comprise chemically converting said precursor fibers under heat, ultraviolet light, high energy radiation, electron beam, or a combination thereof and optionally under a compression stress.

The process may further comprise a step of combining an anode, said polymer hybrid separator, an electrolyte, and a cathode electrode to form a battery.

The disclosure also provides a process for manufacturing the disclosed polymer hybrid separator, the process comprising (A) mixing multiple fibers of the first thermally stable polymer with multiple fibers of the second thermally stable polymers to form a fiber mixture layer, wherein fibers of the first thermally stable polymer intersect (physically contact with) the fibers of the second thermally stable polymer; and (B) heating and partially melting or using a solvent to partially dissolve fibers of the second thermally stable polymer fibers, followed by solidifying the partially melted or dissolved fibers that bond the fibers of the first thermally stable polymer, optionally under a compression stress, to form the polymer hybrid separator comprising a cross-linked network of two types of fibers. Solidification may be simply conducted by cooling the partially melted (surface melted) second type fibers or removing the liquid solvent from the partially dissolved (surface dissolved) second type fibers.

The process may further comprise a step of combining an anode, said polymer hybrid separator, an electrolyte, and a cathode electrode to form a battery.

The lithium battery may be a lithium metal battery, lithium-ion battery, lithium-sulfur battery, lithium-selenium battery, lithium-air battery, etc. The cathode active material in the lithium-sulfur battery may comprise sulfur or lithium polysulfide.

### Example 1: Preparation of Polyamic Acid and Polyimide Nano-Fibers

Representative steps for polymer synthesis and electrospinning are given below:

A certain amount of triphenyl diether dianhydride (HQDPA) and diphenyl ether diamine (ODA) and an appropriate amount of the solvent N,N-dimethyl formamide (DMF) were mixed, and reacted in a polymerization kettle under stirring at 5° C. for 12 hours to obtain a meltable polyimide precursor (polyamic acid) solution (PAA-1) with a mass concentration of 5% and an absolute viscosity of 3.8 Pa·S.

Similarly, a certain amount of biphenyl dianhydride (BPDA) and p-phenylene diamine (PPD) at a molar ratio of 1:1 and an appropriate amount of the solvent N,N-dimethyl formamide (DMF) were mixed, and reacted in a polymerization kettle under stirring at 5° C. for 12 hours to obtain a polyimide precursor (polyamic acid) solution (PAA-2) with a mass concentration of 5% and an absolute viscosity of 4.7 Pa·S.

The PAA-1 polyamic acid solution was subjected to electrostatic spinning in an electric field with an electric field strength of 300 kV/m and concurrently PAA-2 was subjected to electrostatic spinning in an electric field with an electric field strength of 150 kV/m toward the same target surface (collector). A membrane of two types of polyamic acid nanofibers and sub-micron fibers was collected by using a stainless steel roller as a collector. SEM studies indicate that the fiber diameter from PAA-1 was from approximately 65 nm to 125 nm and that from PAA-2 was from 180 nm to 355 nm.

The polyamic acid fiber membrane was put into a high temperature furnace and heated in a nitrogen atmosphere for imidization. The temperature ramping schedule was as follows: heating at a ramp rate of 20° C./min from room temperature to 250° C., maintaining for 30 min at this temperature, then heating at a ramp rate of 5° C./min to 370° C. and maintaining for 30 min at 370° C. The power was turned off, allowing the samples to naturally cool to room temperature. The resulting membrane contains two types of polyimide fibers that are inter- or cross-bonded with one another. The porosity of the nanofiber membrane was approximately 82.4%, and specific surface area of the nanofiber membrane was 32.8 m²/g. DSC and TGA studies indicate that the glass transition temperature was 292° C. and thermal decomposition temperature was 540° C.

### Example 2: Preparation of Aromatic Polyamide Nano-Fibers Bonded by Polyamic Acid Fibers

The aromatic polyamide polymer of the invention was produced by interfacial polymerization according to the method described as follows: 25.13 g of isophthalic acid dichloride (99 mol %) and 0.25 g of terephthalic acid dichloride (1 mol %) were dissolved in 125 ml of tetrahydrofuran having a moisture content of 2 mg/100 ml, and then cooled to −25° C. With stirring of the mixture, a solution of 13.52 g of meta-phenylene diamine (100 mol %) in 125 ml of the above tetrahydrofuran was trickled thereto over about 12 minutes, thereby giving a white emulsion (A). Separately. 13.25 g of anhydrous sodium carbonate was dissolved in 250 ml of water at room temperature. The mixture was cooled to 5° C. with stirring to precipitate sodium carbonate hydrate crystals, thereby giving a dispersion (B). Subsequently, the emulsion (A) and the dispersion (B) were vigorously mixed for 3 minutes. Subsequently, 200 ml of water was added for dilution, and the resulting polymer was precipitated as a white powder. The product was collected from the polymerized system by filtration, washed with water, and dried to obtain the desired polymer.

The obtained polymer was dissolved in N,N-dimethylacetamide to a concentration of 10 wt %, and then allowed to stand at 20° C./60% RH for 24 hours. Nanofibers were produced by electrospinning according to the method described below: The obtained polymer was dissolved in N,N-dimethylacetamide to a concentration of 10 wt %, and electrospinning was performed under an electric field applied at 1 kV/cm to obtain nanofibers that are mixed with polyamic acid fibers being electro-spun concurrently (see below).

For the preparation of polyamic acid, a certain amount of purified triphenyl diether dianhydride (HQDPA) and diphenyl ether diamine (ODA) and an appropriate amount of the solvent N,N-dimethyl formamide (DMF) were mixed, and reacted in a polymerization kettle under stirring at 5° C. for 12 hours to obtain a polyimide precursor (polyamic acid) solution (PAA-3) with a mass concentration of 5% and an absolute viscosity of 3.7 Pa·S. The polyamic acid solution was electro-spun concurrently with electro-spinning of aromatic polyamide nanofibers. The obtained aromatic polyamide nanofibers were observed using a scanning electron microscope to measure the diameter of the fibers. The aromatic polyamide fibers were found to have a diameter within a range of 50 to 200 nm, which are bonded by polyamic acid fibers.

The membrane containing polyamic acid fiber-bonded aromatic polyamide nanofibers was put into a high temperature furnace and heated in a nitrogen atmosphere for imidization. The temperature ramping program was as follows: heating at a ramp rate of 20° C./min from room temperature to 250° C., maintaining for 30 min at this temperature, then heating at a ramp rate of 5° C./min to 340° C. maintaining for 30 min at 340° C., turning off the power, and then naturally cooling to room temperature. The thermal decomposition temperature was found to be 511° C. and porosity of the nanofiber membrane was 83.1%.

### Example 3: Preparation of Solid Electrolyte Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form.

### Example 4: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting solid electrolyte material was then subjected to grinding in a mortar to form a powder sample to be later added as an inorganic solid electrolyte particles dispersed in an intended elastic polymer matrix (examples of thermally stable polymers are given below).

### Example 5: Preparation of Garnet-Type Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25} Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was dispersed in several ion-conducting polymers discussed in below examples.

### Example 6: Preparation of Sodium Superionic Conductor (NASICON) Type Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed consists of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### Example 7: Preparation of Polybenzoxazole (PBO) Fiber-Bonded PAN Fiber Hybrid Separators

A polyacrylonitrile (PAN) membrane, fabricated by a multi-jet electrospinning process, was prepared as follows: an 8 wt % PAN (Aldrich Chemical Company, Inc.)/DMF solution was prepared by slowly adding and dissolving the polymer powders into an organic solvent DMF (N,N-dimethyl formamide) at room temperature. After the solution was completely mixed, it was then loaded into 6 individual syringes, each with a volume of 5 mL. The syringes were fitted with gauge 20 needles and the solution was delivered through Teflon tubes (0.03″ ID) to 6 electrodes, each having a tiny hole with a diameter of 0.025″. The geometry of the electrodes was designed in such a way so that the largest electric field strength could be achieved at the tip of the electrode under a given electric potential, which included a hemispherical tip with a radius of 0.125 inch and a central hole of 0.025 inch diameter. The polymer solution was finally pumped and controlled by a syringe pump at a flow rate of 25 microliters/min. In addition, a 26 kV positive high voltage was applied on the electrodes in order to obtain the existence of six well-stabilized electrospinning jets. The distance from the tip of the electrodes to the grounded collecting plate was 15 cm and the tip of the electrodes were 2 cm apart from each other. The collecting plate was movable and controlled by a step motor. The collecting plate was continually moved at a rate of 1 mm/sec until a highly porous PAN membrane having a relatively uniform thickness of about 30 microns was obtained.

Polybenzoxazole (PBO) fibers were used to bond the PAN fibers. PBO was obtained by thermal conversion from its precursor, methoxy-containing polyaramide (MeO-PA) with a lithium salt and/or inorganic material particles dispersed therein. Specifically, monomers of 4,4′-diamino-3,3′-dimethoxydiphenyl (DMOBPA), and isophthaloyl dichloride (IPC) were selected to synthesize PBO precursors, methoxy-containing polyaramide (MeO-PA) solution. This MeO-PA solution was prepared by polycondensation of DMOBPA and IPC in DMAc solution in the presence of pyridine and LiCl at −5° C. for 2 hr, yielding a 20 wt % pale yellow transparent MeO-PA solution. The inherent viscosity of the resultant MeO-PA solution was 1.20 dL/g measured at a concentration of 0.50 g/dl at 25° C. This MeO-PA solution was diluted to a concentration of 15 wt % by DMAc and added with a lithium salt and/or a plurality of particles of an inorganic material to form a paste.

The as-synthesized MeO-PA paste was electrostatically spun into fibers to mix with the PAN fibers while being spun to form a hybrid precursor membrane. The membrane was dried in a vacuum oven at 100° C. for 4 hr to remove the residual solvent. Then, the resulting membrane having a thickness of approximately 28-32 μm was treated at 200° C.-340° C. under argon gas atmosphere in three steps and annealed for about 2 hr at each step. This heat treatment serves to thermally convert MeO-PA fibers into PBO fibers, which bond the PAN fibers together to impart mechanical strength to the membrane. The chemical reactions involved may be illustrated below:

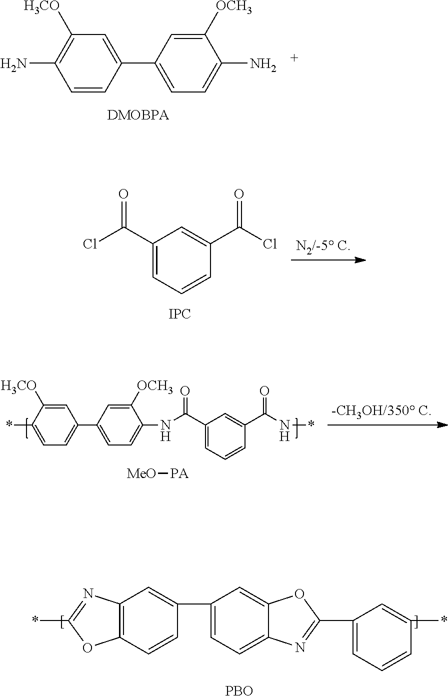

The lithium salts used were lithium hexafluorophosphate, LiPF₆, and lithium borofluoride, LiBF₄, respectively. LGPS-type solid electrolyte and LLZO were used as an inorganic material filler. The lithium ion conductivity values of PBO can be enhanced by 4 orders of magnitude by adding a desired amount of a lithium salt and/or a solid inorganic electrolyte.

### Example 8: Preparation of Polyimide (PI)-Bonded PBO Fibers as Hybrid Separators

As another example, the synthesis of polyimide (PI) involved poly(amic acid) (PAA, formed from pyromellitic dianhydride (PMDA) and oxydianiline (ODA). Prior to use, both chemicals were dried in a vacuum oven at room temperature. Then, 4 g of the monomer ODA was dissolved into 21 g of DMF solution (99.8 wt %). This solution was stored at 5° C. before use. PMDA (4.4 g) was added, and the mixture was stirred for 30 min using a magnetic bar. Subsequently, the clear and viscous polymer solution was separated into four samples. Triethyl amine catalyst (TEA) with 0, 1, 3, and 5 wt % was then added into each sample to control the molecular weight. Stirring was maintained by a mechanical stirrer until the entire quantity of TEA was added. The as-synthesized PAA was kept at −5° C. to maintain properties essential to further processing.

Solvents utilized in the poly(amic acid) synthesis are an important consideration. Common dipolar aprotic amide solvents utilized are DMF, DMAc, NMP and TMU. DMAc was a preferred solvent utilized in the present study. Separately, PBO fibers were obtained by using a process similar to that in Example 7, but the fibers were spun onto a stainless steel collector with reduced overlapping between fibers. The mixture of the intermediate poly(amic acid), inorganic fillers, and separated PBO fibers was cast into a film with a thickness of approximately 18 μm. The Film was first cast on a glass substrate and then allowed to proceed through a thermal cycle with temperatures ranging from 100° C. to 350° C. The procedure entailed heating the poly(amic acid) mixture to 100° C. and holding for one hour, heating from 100° C. to 200° C. and holding for one hour, heating from 200° C. to 300° C. and holding for one hour and slow cooling to room temperature from 300° C. The film was then converted to the final polyimide composite by the thermal imidization route. The resulting membrane was composed of PI-bonded PBO fibers having inter-fiber interstices filled with inorganic particles. The inorganic fillers selected were nano particles of TiO₂, Al₂O₃, SiO₂, and LLZO, separately.

A separator layer was then laminated between a Cu foil and a cathode active layer for use in an anode-less lithium battery (initially the cell being lithium-free) containing a NCM-532 cathode. Another protective layer was disposed between a Cu foil-supported lithium metal foil and a separator in a lithium-sulfur cell containing a graphene/S composite cathode.

### Example 9: Preparation of Polybenzimidazole (PBI) Fiber-Bonded PI Fibers

PBI was prepared by step-growth polymerization from 3,3′,4,4′-tetraaminobiphenyl and diphenyl isophthalate (an ester of isophthalic acid and phenol). The PBI used in the present study was obtained from PBI Performance Products in a PBI solution form, which contains 0.7 dl/g PBI polymer dissolved in dimethylacetamide (DMAc). The polyamic acid solution (prepared by using a process described in Example 1) and PBI solution were electrostatically co-spun into a membrane comprising a network of inter-connected PAA-PBI fibers. The membrane was heat-treated to allow for imidization of PAA into PI fibers.

Three types of battery cells were studied in this example: a lithium/NCM-811 cell (initially the cell being lithium-free), a Si/NCM-811 Li-ion cell, and a lithium-sulfur cell. Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the cells containing a polymer composite separator layer perform very well in terms of cycling stability and the energy storage capacity and yet these cells are flame resistant and relatively safe.

### Example 10: Ladder Polymer-Bonded Composite Separators

As an example of a ladder polymer, a Si-containing ladder polymer was synthesized. This began with the synthesis of a prepolymer. To a 300 ml volume three necked flask substituted with nitrogen, were charged 50 g of methyl vinyl bis-(dimethylamino) silane and 80 ml of n-hexane. Then, 11 mmol of n-butyl lithium in an n-hexane solution were added to carry out polymerization under stirring. After carrying out the polymerizing reaction at a temperature of 40° C. for 3 hours, the reaction solution was dropped in methanol to precipitate the polymer. The polymer was washed and filtered repeatedly for 3-4 times using methanol and then dried under vacuum. The polymer was obtained in an amount of 23.3 g.

In a 500 ml volume three necked flask substituted with nitrogen. 20 g of the prepolymer obtained in the step above were charged and dissolved in 300 ml of toluene. After dissolving, 30 ml of glacial acetic acid were added dropwise to react under a nitrogen stream while stirring at room temperature. After one hour reaction, 1.5 g of dimethyl diacetoxysilane were added and the stirring was continued for 15 min and then 2.5 ml of water were added dropwise to react for 10 min and the reaction was continued for one hour while stirring at room temperature. After the reaction was completed, the resultant solution was transferred to a separating funnel and 200 ml of diethyl ether were added. Then, water was added for washing through shaking to separate the aqueous layer. After repeating the water washing procedure for three times, the organic layer was separated, incorporated with anhydrous potassium carbonate and dried over one night. After filtering out potassium carbonate, the solution was transferred to a flask and heated in a warm water bath to distill off the ether. The solution was electro-spun into a mat of lightly connected PAN fibers having large pores to accommodate incoming PBI nano-fibers which act to bond PAN fibers at points of contact.

Molecular weight measurements indicate that the weight average molecular weight was 1.7×10⁴ and a step ladder polymer comprising 15 segments of the prepolymer hydrolytic condensates was formed. Further, the presence of the silanol group (Si—OH) was observed as the result of the infrared absorption spectroscopy.

An anode, a hybrid separator, and a cathode layer were then stacked together and encased by a protective housing to make a battery cell.

For electrochemical testing, the working electrodes (cathode layers) were prepared by mixing 85 wt. % LiV₂O₅ or 88% of graphene-embraced LiV₂O₅ particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were conducted on cells that are initially lithium metal-free and cells that contain a lithium foil. In the former cells (anode-less cells), a Cu foil coated with a polymer composite separator, and a cathode layer were combined to form a cell, which was injected with an electrolyte solution containing 1 M LiPF₆ dissolved in a mixture of ethylene carbonate (EC) and diethyl carbonate (DEC) (EC-December 1:1 v/v). The cell assembly was performed in an argon-filled glove-box. For comparison purposes, cells with the conventional Celgard 2400 membrane (porous PE-PP film) as a separator. The CV measurements were carried out using a CH-6 electrochemical workstation at a scanning rate of 1-100 mV/s. The electrochemical performance of the cell featuring the polymer composite separator and that containing a conventional separator were evaluated by galvanostatic charge/discharge cycling at a current density of 50 mA/g using an Arbin electrochemical workstation.

The specific intercalation capacity curves of two lithium cells each having a cathode containing LiV₂O₅ particles (one cell having a thermally stable polymer composite-based separator and the other a conventional separator) were obtained and compared. As the number of cycles increases, the specific capacity of the conventional cells drops at a very fast rate. In contrast, the presently invented polymer composite-based protection layer provides the battery cell with a significantly more stable and high specific capacity for a large number of cycles. These data have demonstrated the surprising and superior performance of the presently invented high-temperature ladder polymer/PAN hybrid separator approach.

### Example 11: Polybenzobisimidazole (PBBI) Rigid-Rod/Ladder Polymer Fibers Bonded by Aromatic Nano-Fibers

In a representative procedure, 1,2,4,5-Tetraminobenzene tetrahydrochloride (TABH) (4.0 g, 14.18 mmol) was dissolved in 77% polyphosphoric acid (PPA) (12 g). The 77% PPA was prepared by combining polyphosphoric acid and 85% phosphoric acid. The thus formed solution of TABH in PPA was placed in a glass reactor fitted with a mechanical stirrer, two gas ports and a side arm. The reaction vessel was purged with nitrogen for 20 minutes and thereupon maintained at a temperature of 80° C. under vacuum for 24 hours. After this treatment, complete dehydrochlorination occurred and the reaction mixture was cooled to 50° C. under a nitrogen atmosphere.

Subsequently, oxalic acid (1.277 g, 14.18 mmol) and phosphorus pentoxide (P₂O₅) (8 g), the P₂O₅ to compensate for the calculated water of condensation, was added to the dehydrochlorinated product. The reaction temperature was raised to 120° C. and held at this temperature for 10 hours. The reaction temperature was then raised to 140° C. and finally to a range of 180° to 200° C. The solution was then submitted to electro-spinning to produce nano-fibers while the aromatic polyamide solution was being spun into fibers. The membrane was further heat treated in the temperature range of 180° to 200° C. for 24 hours to complete the reactions.

In conclusion, the thermally stable polymer fiber-bonded fibers, as a hybrid separator, is a surprisingly effective strategy in alleviating the problems of lithium metal dendrite formation and lithium metal-electrolyte reactions that otherwise lead to rapid capacity decay and potentially internal shorting and explosion of the lithium secondary batteries. The thermally stable polymer fibers can be used to bond fibers of another thermally stable polymer to produce a network of cross-linked fibers, preventing collapsing of the separator under a high temperature environment. The network of bonded fibers provides a supporting framework of structural integrity that can be porous to accommodate a liquid or semi-liquid electrolyte. Alternatively, the bonded fibers, when in combination with a plurality of particles of an inorganic solid electrolyte, can serve as a composite separator having a good ion conductivity.

What is claimed:

1. A polymer hybrid separator for use in a battery, the polymer hybrid separator comprising multiple fibers of a first thermally stable polymer, herein referred to as first fibers, and multiple fibers of a second thermally stable polymer, herein referred to as second fibers, which are different in chemical composition or diameter than the first fibers, wherein the first fibers intersect the second fibers and are bonded to the second fibers at multiple points of intersection and wherein the first thermally stable polymer, the second thermally stable polymer, or both the first and the second thermally stable polymer are selected from the group consisting of polyimide, poly(amic acid), poly(amide imide), poly(ether imide), aromatic polyamide, polysulfone, polyether sulfone, poly(phenylene sulfide), poly(phenylene sulfide sulfone), phenolic resin, polyacrylonitrile, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly(p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzo-phenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof and wherein the hybrid separator has a thickness from 50 nm to 300 μm.

2. The polymer hybrid separator of claim 1, wherein said separator further comprises an inorganic material selected from (a) particles or fibers of a transition metal oxide, aluminum oxide, silicon dioxide, transition metal sulfide, transition metal selenide, alkylated ceramic particles, metal phosphate, metal carbonate, or a combination thereof or (b) particles or fibers of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

3. The polymer hybrid separator of claim 1, wherein said separator further comprises from 0.1% to 30% by weight of a lithium salt.

4. The polymer hybrid separator of claim 3, wherein said lithium salt is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

5. The polymer hybrid separator of claim 1, wherein said separator has a porosity level from 5% to 95% by volume, preferably from 30% to 85%.

6. The polymer hybrid separator of claim 1, wherein said separator has pores that are filled with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethanurea, polymethyl acrylate, polymethyl methacrylate, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

7. The polymer hybrid separator of claim 1, wherein said separator further comprises a flame-retardant additive.

8. The polymer hybrid separator of claim 7, wherein said flame-retardant additive is selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

9. A lithium secondary battery or sodium secondary battery, comprising a cathode, an anode, and a polymer hybrid separator of claim 1 disposed between said cathode and said anode, and a working electrolyte.

10. The secondary battery of claim 9, wherein said working electrolyte is a liquid electrolyte, polymer gel electrolyte, solid polymer electrolyte, quasi-solid or semi-solid electrolyte, inorganic solid electrolyte, or composite electrolyte, wherein the quasi-solid electrolyte has a lithium salt dissolved in an organic or ionic liquid with a lithium salt concentration higher than 2.0 M.

11. The secondary battery of claim 9, wherein said working electrolyte comprises particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

12. A process for manufacturing the polymer hybrid separator of claim 1, the process comprising (A) mixing multiple fibers of the first thermally stable polymer with multiple fibers of an chemically active precursor to the second thermally stable polymers to form a fiber mixture layer, wherein fibers of the first thermally stable polymer intersect (physically contact with) the precursor fibers; and (B) chemically converting the precursor fibers to the second thermally stable polymer fibers which bond the fibers of the first thermally stable polymer to form said polymer hybrid separator comprising a cross-linked network of two types of fibers.

13. The process of claim 12, wherein said multiple fibers of the second thermally stable polymer also bond to one another.

14. The process of claim 12, wherein said step (A) comprises (i) electrostatically co-spinning fibers of the first thermally stable polymer and precursor fibers of the second thermally stable polymer to form a membrane layer, or (ii) preparing a porous structure comprising multiple fibers of the first thermally stable polymer and electro-spinning precursor fibers of the second thermally stable polymer to intersect the first fibers.

15. The process of claim 12, wherein said step (B) comprises chemically converting said precursor fibers under heat, ultraviolet light, high energy radiation, electron beam, or a combination thereof.

16. The process of claim 15, wherein step (B) is performed under a compression stress.

17. A process for manufacturing the polymer hybrid separator of claim 1, the process comprising (A) mixing multiple fibers of the first thermally stable polymer with multiple fibers of the second thermally stable polymers to form a fiber mixture layer, wherein fibers of the first thermally stable polymer intersect (physically contact with) the fibers of the second thermally stable polymer; and (B) heating and partially melting or using a solvent to partially dissolve fibers of the second thermally stable polymer fibers, followed by solidifying the partially melted or dissolved fibers that bond the fibers of the first thermally stable polymer, to form said polymer hybrid separator comprising a cross-linked network of two types of fibers.

18. The process of claim 17, wherein step (B) is performed under a compression stress.

19. The process of claim 12, further comprising a step of combining an anode, said polymer hybrid separator, an electrolyte, and a cathode electrode to form a battery.

20. The process of claim 17, further comprising a step of combining an anode, said polymer hybrid separator, an electrolyte, and a cathode electrode to form a battery.
